(19) United States
(12) Patent Application Publication
(10) Pub. No.: US 2023/0069627 A1
(43) Pub. Date: Mar. 2, 2023

(54) ANTIBACTERIAL GLASS COMPOSITION AND PREPARATION METHOD THEREFOR

(71) Applicant: LG ELECTRONICS INC., Seoul (KR)

(72) Inventors: Namjin KIM, Seoul (KR); Daesung KIM, Seoul (KR); Young Seok KIM, Seoul (KR)

(21) Appl. No.: 17/786,013

(22) PCT Filed: Dec. 16, 2020
(86) PCT No.: PCT/KR2020/018476

§ 371 Date: Jun. 16, 2022

(30) Foreign Application Priority Data
Dec. 17, 2019 (KR) 10-2019-0168501
Feb. 26, 2020 (KR) 10-2020-0023885

(51) Int. Cl. C03C 3/064; C03C 3/078; C03C 4/20

(52) U.S. Cl. CPC C03C 3/064; C03C 3/078; C03C 4/20; C03C 2203/10; C03C 2204/02

(57) ABSTRACT

There is disclosed an antibacterial glass composite that may be made of components harmless to the human body and have excellent durability and chemical resistance, thereby maintaining an antibacterial function for a long time, and a manufacturing method thereof.

### BACKGROUND

### Technical Field

The present disclosure relates to an antibacterial glass composite having antibacterial properties and a manufacturing thereof.

### Background Art

Microorganisms such as germs, fungi and bacteria are ubiquitous in our living spaces (e.g., washbasins, refrigerator shelves and washing machines). If these microbes get into our bodies, they cause life-threatening infections. Accordingly, there is a need for an antibacterial glass composite that is capable of controlling the spread of microorganisms in household items such as washbasins, refrigerator shelves, ovens or washing machines.

According to a conventional method, the number of hydrogen cations generated from moisture and metal oxides is increased by including various oxides in an antibacterial glass composite. Accordingly, an aqueous medium creates an acidic environment, and the acidic environment kills microorganisms. However, such the conventional antibacterial glass composite is weak in water resistance and has a disadvantage that an acidic environment must be created.

There are well known antibacterial glass composites that express antibacterial activity by eluting ions such as Ag, Zn and Au. However, those components are harmful to the human body and expensive. The antibacterial glass composite containing those components may be expensive to manufacture and may threaten the health of the user.

In addition, the antibacterial power of the ion-eluting antibacterial glass composite described above may be expressed from the elution of ions. Accordingly, the durability of the antibacterial glass may gradually decrease over time.

To fabricate such a plastic material, a polymer resin is injection molded to fabricate a plastic injection molded product, and various additives are added depending on the purpose of use during the injection molding.

However, white plastics might unintentionally darken or turn gray during the injection molding process for fabricating the plastic injection molded product.

Accordingly, a white pigment is intentionally added to the polymer resin during the conventional injection molding process. Due to the addition of such a white pigment, there is a problem in that the manufacturing cost increases.

### Cited Patent Reference

### Cited Document 1

Japanese Patent No. 3845975

### Cited Document 2

Korean Patent Publication No. 10-2016-0124193

### Description of Disclosure

### Technical Problems

Accordingly, an object of the present disclosure is to address the above-noted and other problems and to provide a novel antibacterial glass composition that has excellent durability and a permanent antibacterial effect even when metal ions are not eluted.

Another object of the present disclosure is to provide a novel antibacterial glass composition that may implement the exterior color of an injection molded product in yellow or brown despite of containing Cu.

A further object of the present disclosure is to provide a permanent and economical antibacterial glass composition that may be used as an additive of a coating material or a plastic injection molded product for a glass shelf.

A still further object of the present disclosure is to provide an antibacterial glass composition made of components that are harmless to the human body and having high durability and chemical resistance to maintain antibacterial function for a long period of time, and a manufacturing method thereof.

A still further object of the present disclosure is to provide an antibacterial glass composition that may not only serve as an antibacterial agent capable of satisfying the appearance specifications of a white-based injection molded product but also as a white pigment by controlling each component and a component ratio.

### Technical Solutions

To solve the above technical problems, an object of an antibacterial glass composite according to the present disclosure may be to appropriately control the content amount of Ag, Cu and Fe and the content ratio of the other components.

More specifically, the antibacterial glass composition may include 20 to 60 % by weight (or wt) of SiO₂; 5 to 20% wt of B₂O₃; 10 to 20% wt of at least one of Na2O, K₂O and Li₂O; 20 to 35% wt of at least one of ZnO, CaO and MgO; to 0.1 %wt of Ag₂O; 2 to 6 % wt of Cuo; and 4 to 15 % wt of Fe₂O₃, thereby having excellent durability and excellent antibacterial activity, and enabling an exterior color of its injection molded product to show a yellow color and a brown color.

In the antibacterial glass composite, the content ratio of Fe₂O₃ to CuO satisfies the following formula:

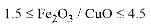

An antibacterial glass composite according to another embodiment of the present disclosure may be a novel silicate-based glass composite having excellent durability and chemical resistance to maintain an antibacterial function for a long time, and may be a permanent and economical antibacterial agent that can be used as an additive for plastic injection molded product functioning as a white pigment at the same time.

To this end, the antibacterial glass composite according to this embodiment may include Ag₂O that is the most effective component in showing no color but antibacterial activity, instead of excluding the component having excellent antibacterial activity but makes the glass colored such as CuO.

In addition, P₂O₅ and B₂O₃ may be added in a large amount together, in addition to SiO₂, and then used as a glass former to induce Ag to homogeneously exist as ions in the glass composite.

More specifically, an antibacterial glass composite according to another embodiment 20 to 40 % by weight (or wt) of SiO₂; 25 to 45% wt of the sum of B₂O₃ and P₂O₅; 5 to 20% wt of at least one of Na₂O, K₂O and Li₂O; 0.1 to 10 %wt of Alg₂O₃; 5 to 15%wt of TiO₂; 1 to 8 %wt of ZnO; and 0.1 to 2%wt of Ag₂O.

### Advantageous Effect

The present disclosure may have following advantageous effects. The antibacterial glass composite according to the present disclosure may control the content ratio of the components, thereby having excellent durability and excellent antibacterial activity.

In particular, the antibacterial glass composite according to the present disclosure may create a strong glass matrix that will not react with water, thereby having excellent durability. In addition, the antibacterial glass composite according to the present disclosure may optimize the content ratio of the components showing antibacterial activity, thereby having excellent antibacterial activity in addition to the excellent durability.

In addition, the antibacterial glass composite according to the present disclosure may adjust the content amount of Cu and Fe components, thereby realizing the exterior color of the injection molded product as yellow and brown colors.

In addition, the antibacterial glass composite according to the present disclosure may be used as a multi-purpose antibacterial agent that may be applied to various product groups.

In addition, the antibacterial glass composite and the preparation method thereof according to another embodiment of the present disclosure may be made of the components that are harmless to the human body and having high durability and chemical resistance, thereby maintaining the antibacterial function for a long time.

In addition, the antibacterial glass composite and the preparation method thereof according to another embodiment of the present disclosure may control the components and the content ratio, thereby functioning as an antibacterial agent satisfying the external appearance specifications of a white-based injection molding product, and also functioning as a white pigment.

Accordingly, the antibacterial glass composite according to this embodiment of the present disclosure may be a novel Silicate-based glass composite having high durability and chemical resistance, thereby not only maintaining the antibacterial function for a long time but also being used as an additive agent for a plastic injection molded product serving as a white pigment.

In addition, when used as the additive agent for the plastic injection molded product, the antibacterial glass composite according to this embodiment may secure the antibacterial activity and functioning as the white pigment, even without adding a separate white pigment, thereby reducing the manufacturing cost due to excluding the user of white pigment.

Specific effects are described along with the above-described effects in the section of Detailed Description.

### BRIEF DESCRIPTION OF DRAWINGS

FIG. 1 is a view showing colors of embodiments according to the present disclosure and comparative embodiments; and

FIG. 2 is a flow chart showing an antibacterial glass powder preparation method according to an embodiment of the present disclosure.

### DETAILED DESCRIPTION OF EXEMPLARY EMBODIMENT

The above-described aspects, features and advantages are specifically described hereunder with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague. Below, preferred embodiments according to the disclosure are specifically described with reference to the accompanying drawings. In the drawings, identical reference numerals can denote identical or similar components.

Hereinafter, expressions of ‘a component is provided or disposed in an upper or lower portion’ may mean that the component is provided or disposed in contact with an upper surface or a lower surface. The present disclosure is not intended to limit that other elements are provided between the components and on the component or beneath the component.

It will be understood that when an element is referred to as being “connected with” or “coupled to” another element, the element can be directly connected with the other element or intervening elements may also be present. In contrast, when an element is referred to as being “directly connected with” another element, there are no intervening elements present.

Throughout the specification, unless otherwise stated, each element may be singular or plural.

The singular forms “a”, “an” and “the” are intended to include the plural forms as well, unless explicitly indicated otherwise. It should be further understood that the terms “comprise” or “include” and the like, set forth herein, are not interpreted as necessarily including all the stated components or steps but can be interpreted as excluding some of the stated components or steps or can be interpreted as including additional components or steps.

Throughout the disclosure, the terms “A and/or B” as used herein can denote A, B or A and B, and the terms “C to D” can denote C or greater and D or less, unless stated to the contrary.

Hereinafter, an antibacterial glass composition according to the present disclosure and a manufacturing method thereof will be described in detail.

### Antibacterial Glass Composition 1

The antibacterial glass composition according to an embodiment of the present may include 20 to 60 % by weight (i.e., wt) of SiO₂; 5 to 20 %wt of B₂O₃; 10 to 20 %wt of at least one of Na₂O, K₂O and Li₂O; 20 to 35 %wt of at least one of ZnO, CaO and MgO; 0.01 to 0.1 %wt of Ag₂O; 2 to 6% wt of CuO; and 4 to 15% wt of Fe₂O₃.

The antibacterial glass composition according to the present disclosure may be excellent in both durability and antibacterial power, and have characteristics configured to give yellow and brown color to the exterior of an injection molded product. Hereinafter, the components contained in the antibacterial glass composition according to the present disclosure will be described in detail.

SiO₂ is a key component configured to form a glass structure and serve as a frame of the glass structure. The antibacterial glass composite according to the present disclosure may contain SiO₂ in an amount of 20 to 60 wt%. SiO₂ forms less OH groups on a glass surface, compared to P₂O₅ which is a representative glass former so that it is advantageous in facilitating metal ions to positively charge the glass surface. Preferably, the antibacterial glass composite according to the present disclosure may include only SiO₂ as the glass former, without P₂O₅. When SiO₂ is contained in an amount exceeding 60% wt, there could be a problem in that workability and production yield are deteriorated in a quenching process as the viscosity increases in a glass melting process. Conversely, when SiO₂ is added in an amount of less than 20%wt, there could be a problem in that the glass structure is weakened and water resistance is lowered.

B₂O₃ may be a component serving as a glass former to enable vitrification of the glass composition, together with SiO₂. Since it has a low melting point, B₂O₃ may be a component that not only lowers the eutectic point of a melt material but also serves to facilitate vitrifcation of the glass composition. Since it includes a large amount of metal components expressing antibacterial activity, the antibacterial glass composition according to the present disclosure should include an appropriate amount of B₂O₃. However, if B₂O₃ is included in the antibacterial glass composite in a predetermined proper amount or more, the bonding structure of glass could weakened, thereby deteriorating the durability or water resistance of the glass. In consideration of balance with the other components, the antibacterial glass composite according to the present disclosure may include 5 to 20% wt of B₂O₃. If B₂O₃ is included in an amount exceeding 20% wt, the bonding structure of glass might weakened as described above, thereby causing a problem of deteriorating the durability or water resistance of the glass. Conversely, if B₂O₃ is included in an amount less than 5% wt, there could be a problem in that vitrification is difficult.

In the antibacterial glass composite according to the present disclosure, the content of SiO₂ may be greater than that of B₂O₃. If the content of B₂O₃ is greater than that of SiO₂, the durability or water resistance of the glass might weakened.

Alkali oxides such as Na₂O, K₂O and Li₂O are oxides configured to act as a network modifier for non-cross linking in the glass composition. Those components cannot be vitrified along but vitrification may be possible when they are mixed with a network former such as SiO₂ and B₂O₃ in a certain ratio. If only one of those components is contained in the glass composition, the durability of the glass might be weakened in an area where vitrification is possible. However, when two or more of those components are contained in the glass composition, the glass durability may be increased again. The antibacterial glass composite according to the present disclosure may include 10 to 20% wt of at least one of Na₂O, K₂O and Li₂O. If at least one of Na₂O, K₂O and Li₂O is contained in the glass composite in an amount exceeding 20% wt, the durability of the glass composite might be drastically deteriorated. Conversely, if at least one of Na₂O, K₂O and Li₂O is added in an amount of less than 1 %wt, vitrification could be difficult.

ZnO and CaO may be components that serve as a network former and a network modifier in the glass structure. In addition, they are ones of the key components that express the antibacterial activity of the glass composition. The antibacterial glass composite according to the present disclosure may include 20 to 35% wt of at least one of ZnO, CaO and MgO. If at least one of ZnO, CaO and MgO is contained in an amount less than 20% wt, it could be difficult to express the antibacterial activity of the glass composite. Conversely, if at least one of ZnO, CaO and MgO is added in a large amount exceeding 35%wt, the durability or thermal properties of the glass composite might be deteriorated.

Ag₂O, CuO and Fe₂O₃ may be key components that express the antibacterial activity of the glass composite in the present disclosure. When contained in SiO₂-based glass, Ag₂O could readily precipitate as Ag metal. Accordingly, to prevent the precipitation of Ag₂O, B₂O₃ should be contained in the glass in an appropriate amount. However, if the content of B₂O₃ in the glass is too large, the bonding structure of the glass might weaken and the water resistance of the glass might be deteriorated. The conventional antibacterial glass composite expresses the antibacterial activity by facilitating the elution of CuO and Ag₂O. However, the antibacterial glass composite according to the present disclosure may express the antibacterial activity by enabling Ag₂O, CuO and Fe₂O₃ to be positively charged. To express the above-described mechanism, the antibacterial glass composite according to the present disclosure may include 0.01 to 0.1 %wt of Ag₂O; 2 to 6 %wt of CuO; and 4 to 15 %wt of Fe₂O₃. When CuO is contained in an amount exceeding 6%wt, Cu might be precipitated on the surface of the glass and heterogeneous glass might be formed. Also, when Ag₂O is contained in an amount exceeding 0.1 %wt, Ag might be precipitated and the surface of the glass and heterogeneous glass might be formed. Similarly, when Fe₂O₃ is contained in an amount exceeding 15 %wt, Fe might be precipitated and the surface of the glass and heterogeneous glass might be formed. Conversely, when those components are contained in an amount less than the minimum value, the antibacterial power might be deteriorated.

Preferably, the total content of Fe₂O₃ and CuO may be less than 20%wt. When the sum of CuO and Fe₂O₃ is 20%wt or less, the bonding structure of the glass may be strengthened enough to improve water resistance, but when the sum is more than 20%wt, precipitation could occur on the glass surface only to obtain heterogeneous glass.

### Manufacturing Method of Antibacterial Glass Composite 1

Next, a manufacturing method of the antibacterial glass composite according to the present disclosure will be described in detail.

The manufacturing method of the antibacterial glass composite according to the present disclosure may include a process of preparing the above-described antibacterial glass composite; a process of melting the antibacterial glass composite materials; and a process of forming the antibacterial glass composite by cooling the melted antibacterial glass composite on a quenching roller.

The antibacterial glass composite materials may be sufficiently mixed and melted. Preferably, the antibacterial glass composite materials may be melted in a temperature range of 1200 to 1300° C. The antibacterial glass composite materials may be melting for 10 to 60 minutes.

Hence, the melted antibacterial glass composite material may be quenched by using a chiller and a quenching roller, thereby forming the antibacterial glass composite.

### Method of Applying the Antibacterial Glass Composite 1

Next, the antibacterial glass composite according to the present disclosure may be coated on one surface of a target object. The target object may be a metal plate, a tempered glass plate, a part or all of a cooking appliance. The coating method may include a method of applying a coating solution to the surface of the target object and firing it or a method of spraying the coating solution. However, the coating method is not limited thereto. the antibacterial glass composite may be fired at a temperature range of 700 to 750° C. for 300 to 450 seconds.

In addition, the antibacterial glass may be applied to a plastic resin injection molded product as an additive. The antibacterial glass powder according to the present disclosure may be contained in the plastic resin injection molded product in an appropriate amount only to give the antibacterial power to the surface of the injection molded product.

### Antibacterial Glass Composite 2

An antibacterial glass composite according to another embodiment of the present disclosure may be made of a component that is harmless to the human body, and may have high durability and chemical resistance to maintain the antibacterial function for a long time.

In addition, the antibacterial glass composition according to the embodiment of the present disclosure may serve as an antibacterial agent satisfying the appearance specifications of a white-based injection molded product and also as a white pigment by controlling the components and the component ratio.

For that, the antibacterial glass composite according to this embodiment may include 20 to 40%wt of SiO₂; 25 to 45%wt of the sum of B₂O₃ and P₂O₅; 5 to 20 %wt of at least one of Na₂O, K₂O and Li₂O; 0.1 to 10 %wt of Al₂O₃; 5 to 15 %wt of TiO₂; 1 to 8%wt of ZnO; and 0.1 to 2 %wt of Ag₂O.

As a result, the antibacterial glass composite according to this embodiment may be a novel Silicate-based glass composite having high durability and high chemical resistance, so that it can maintain the antibacterial function for a long time. Also, the antibacterial glass composite may be a permanent and economical antibacterial agent capable of serving as a white pigment and as an additive of a plastic injection molded product.

Since it has a limitation in that the bulk glass is opacified to produce a white color, the antibacterial glass composite according to this embodiment should be realized as the antibacterial glass made of the components capable of expressing antibacterial activity, without showing a color.

Accordingly, Ag₂O that is the most effective component in expressing the antibacterial activity without showing any color may be added instead of excluding the component that makes the glass show a color. However, when Ag₂O is added to a Silicate-based glass composite to proceed with vitrification, Ag that is a material with strong reducing power may not exist as ions uniformly in the glass composite but it may be precipitated as Ag itself. To prevent that, a large amount of P₂O₅ and B₂O₃ may be further added, together with SiO₂. Accordingly, Ag may be induced to exist as ions homogenously in the glass composition by using Ag as a glass former.

In addition, to opacify (i.e., crystallize) the glass in the present disclosure, it may be necessary to combine the components that can easily express crystallization in the glass composite. To this end, TiO₂ serving as a crystallization seed may be used and P₂O₅ may be added in an amount of 8%wt or more to promote crystallization.

Hereinafter, the functions and contents of the components contained in the antibacterial glass composition according to another embodiment of the present disclosure will be described in detail.

SiO₂ is a glass former configured to facilitate vitrification, and a key component that serves as a structural framework of glass. In addition, although not acting as a direct component for expressing antibacterial activity, SiO₂ forms less OH groups on a glass surface, compared to P₂O₅ which is a representative glass former so that it is advantageous in facilitating metal ions to positively charge the glass surface.

SiO₂ may be preferably contained in a content ratio of 20 to 40% wt of the total weight of the antibacterial glass composition according to the present disclosure. 34 to 39% wt may be more preferred. When SiO₂ is added in a large amount in excess of 40%wt, there could be a problem in that workability and production yield are deteriorated in a cooling process as the viscosity increases in a glass melting process. Conversely, when SiO₂ is added in an amount of less than 20%wt, there could be a problem in that the glass structure is weakened and water resistance is lowered.

B₂O₃ and P₂O₅ may be a component serving as a glass former to enable vitrification of the glass composition, together with SiO₂. B₂O₃ and P₂O₅ may have different structures in glass. Si has 4 coordination numbers and B has 3 or 3 coordination numbers, and P has 4 coordination numbers. The single boning strength with oxygen (kcal/mol) is 106 and 89 to 119 (because there are two coordination numbers), and 88 to 111 (because there is a double bonding structure with oxygen), respectively. Since the Si-O single bonding strength of SiO₂ is stronger than that of the other components, it may be relatively easy to reduce Ag to a metallic state.

The Si-O bonding strength may be greater than the bonding strength with Ai ions. Also, Ag may be a component with a low reactivity among various materials contained in the glass, and a great strength to exist as metal itself. However, to become a glass expressing antibacterial activity by using Ag, it may be necessary to create a state in which Ag is homogenously distributed in an ionic state in the glass.

Accordingly, in order to induce Ag ionization by including a large amount of B and P, which is capable of existing in a state with a smaller single bonding strength with oxygen than Si, 25 %wt or more of the sum of B₂O₃ and P₂O₅ may be added in this embodiment of the present disclosure. However, when the content of the sum of B₂O₃ and P₂O₅ exceeds 45%wt, it might disturb with the contents of the other components only to rather deteriorate the antibacterial activity. Accordingly, it is preferred that the sum of B₂O₃ and P₂O₅ is added in a content ratio of 25 to 45%wt of the total weight of the antibacterial glass composite.

In this embodiment of the present disclosure, when P₂O₅ is added in an amount of less than 8%wt, it might be difficult to opcify the glass and then to perform a function as a white pigment. Accordingly, B₂O₃ may be added in an amount of 20 to 40%wt of the total weight of the antibacterial glass composite according to this embodiment of the present disclosure, and P₂O5 may be more strictly controlled to a content ratio of 8%wt or more. 8 to 15%wt may be more preferable.

Alkali oxides such as Na₂O, K₂O and Li₂O are oxides configured to act as a network modifier for non-cross linking in the glass composition. Those components cannot be vitrified along but vitrification may be possible when they are mixed with a network former such as SiO₂ and B₂O₃ in a certain ratio. If only one of those components is contained in the glass composition, the durability of the glass might be weakened in an area where vitrification is possible. However, when two or more of those components are contained in the glass composition, the glass durability may be increased again. This is called ‘Mixed alkali effect’

Accordingly, it is preferred that at least one of Na₂O, K₂O and LI₂O is contained in a content ratio of 5 to 20 %wt based on the total weight of the antibacterial glass composition according to the present disclosure. When one or more of Na₂O, K₂O and Li₂O is added in a large amount exceeding 20 %wt, the thermal properties of the glass composition could be deteriorated. Conversely, when one or more of Na₂O, K₂O and Li₂O is added in an amount of less than 5 %wt, it could be difficult to control the valence of a component such as ZnO and the antibacterial activity may be then deteriorated.

However, when LiO is contained in a large amount exceeding 3 % wt, vitrification might be difficult and the possibility of devitrification might increase. Accordingly, it is more preferable that Li₂O is strictly controlled in a content ratio of 3% wt or less of the total weight of the antibacterial glass composition according to the present disclosure.

Al₂O₃ may be components configured to improve the chemical durability and heat resistance of glass. It is preferred that Al₂O₃ is added in a content ratio of 0.1 to 10% wt of the total weight of the antibacterial glass composition according to the present disclosure. When Al₂O₃ is added to an amount of less than 0.1 %wt, the durability of glass might be deteriorated. Conversely, when Al₂O₃ is added in a large amount exceeding 10 %wt, devitrification might occur during the cooling process out of the vitrification area or immiscibility might occur.

TiO₂ may be a component configured to improve chemical durability and heat resistance of glass, like Al₂O₃. It is preferred that TiO₂ is added in a content ratio of 5 to 15%wt of the total weight of the antibacterial glass composite according to this embodiment of the present disclosure. When TiO₂ is added in an amount less than 5%wt, the glass durability might be deteriorated. Conversely, when TiO₂ is added in a large amount exceeding 15%wt, devitrification or immiscibility might occur during the cooling process out of the vitrification zone.

ZnO may be a component that serves as a network former and a network modifier in the glass structure. In addition, it may be one of the key components that express the antibacterial activity of the glass composition.

ZnO may be contained in a content ratio of 1 to 8 %wt of the total weight of the antibacterial glass composition according to the present disclosure. When ZnO is added less than 1 % wt, it might be difficult to express the antibacterial activity of the glass composition. Conversely, when ZnO is added in a large amount exceeding 8%wt, the durability or thermal properties of the glass composition might be deteriorated.

Ag₂O may exist in an ionic state in the glass, and may be an effective component in expressing the antibacterial activity.

Ag₂O may be added in a content ratio of 0.1 to 2%wt of the total weight of the antibacterial glass composite according to this embodiment. When Ag₂O is added in an amount of less than 0.1%wt, it might be difficult to express the effect of the antibacterial activity improvement. Conversely, when Ag₂O is added in a large amount of exceeding 2%wt, there might a possibility of making vitrification unstable by precipitation of silver metal.

Hereinafter, referring to the accompanying drawings, a preparation method of antibacterial glass powder according to an embodiment of the present disclosure will be described.

FIG. 2 is a flow chart showing an antibacterial glass powder preparation method according to an embodiment of the present disclosure.

As shown in FIG. 2, the antibacterial glass powder preparation method according to the embodiment of the present disclosure may include a mixing process S110, a melting process S120, a cooling process S130 and a grinding process S140.

### Mixing

In the mixing process S110, 20 to 40 % wt of SiO₂, 25 to 45% wt of the sum of B₂O₃ and P2O5, 5 to 20% wt of at least one of Na₂O, K₂O and Li₂O, 0.1 to 10 %wt of Al₂O₃, 5 to 15%wt of TiO₂, 1 to 8 % wt of ZnO, and 0.1 to 2 %wt of Ag₂O may be mixed and agitated, thereby forming the antibacterial glass composition.

Here, 20 to 40%wt of B₂O₃ may be added and 8%wt or more of P2O5 may be added.

In addition, it is preferred that 8 to 15%wt of P₂O₅ is added.

In addition, it is more preferred that 3%wt or less of Li₂O is added.

### Melting

In the melding process S120, the antibacterial glass composition may be melted.

In this process, the melting may be performed at 1,200 to 1,300° C. for 1 ~ 60 minutes. If the melting temperature is less than 1,200° C. or the melting time is less than 1 minute, the antibacterial glass composition cannot be completely melted, thereby causing immiscibility of glass melt. Conversely, if the melting temperature exceeds 1,300° C. or the melting time exceeds 60 minutes, excessive energy and time may be required, thereby not being economical.

### Cooling

In the cooling process S130, the melt antibacterial glass composition may be cooled to a room temperature.

In this process, cooling may be performed in a method of cooling in furnace. When air cooling or water cooling is applied, the internal stress of the antibacterial glass might be severely formed and it might cause cracks in some cases. Accordingly, the cooling in furnace is preferred as the cooling method.

### Grinding

In the grinding step S140, the cooled antibacterial glass may be grinded. At this time, a dry grinder may be used for grinding.

The antibacterial glass may be finely pulverized to prepare antibacterial glass powder. The antibacterial glass power may preferably have an average diameter of 30 µm or less. The more preferable average diameter may be 15 to 25 µm.

### Embodiment 1

### Manufacturing the Antibacterial Glass Composite

The antibacterial glass composite with a content ratio shown in Table 1 below. The components may be sufficiently mixed in V-mixer for 3 hours. In this instance, Na₂CO₃, K₂CO₃, Li₂CO₃ and CaCO₃ are used as raw materials for raw materials for Na₂O, K₂O, Li₂O and CaO, and the other components are the same as those shown in Table 1. The mixed materials is sufficiently melted for 30 minutes and quenched on a quenching roller, thereby obtaining a glass cullet.

The glass cullet obtained in the above process is pulverized for about 5 hours using a grinder (i.e., a jet mill) after controlling the initial particle size with the ball mill. The pulverized particles pass through a 325 mesh sieve (ASTM C285-88) to control the D50 particle size to 5 to 15 µm, and finally antibacterial glass powder is prepared.

Table 1

| components | Embodiment 1 | Embodiment 2 | Embodiment 3 | Comparative embodiment 1 | Comparative embodiment 2 |
|---|---|---|---|---|---|
| SiO₂ | 23.6 | 35.1 | 33.9 | 26 | 30.6 |
| B₂O₃ | 18.2 | 6.8 | 6.1 | 20 | 23.5 |
| Na₂O | 10 | 10.7 | 9.1 | 11 | 12.9 |
| K₂O | 5.5 | 5.9 | 4.5 | 6 | 7.1 |
| Li₂O | 1.8 | | | 2 | 2.4 |
| ZnO | 27.3 | 19.5 | 19.5 | 30 | 23.5 |
| CaO | | 9.8 | 4.9 | | |
| MgO | | | 4.9 | | |
| CuO | 4.5 | 2.4 | 4.9 | | |
| Fe₂O₃ | 9 | 9.75 | 12.19 | 5 | |
| Ag₂O | 0.1 | 0.05 | 0.01 | | |

### Manufacturing of Antibacterial Glass Added Plastic Injection Molded Product

An injection-molded product having a level of 200 mm × 100 mm and a thickness of 3 mm is prepared using polypropylene resin. Three injection molded products each containing 4%wt of the antibacterial glass powder according to Embodiments 1 to 3, and three injection molded products each containing 4% wt of the antibacterial glass powder according to Comparative embodiments 1 to 3 are prepared. An experiment on the anti-biofilm is carried out on the six injection molded products.

### Experiment Embodiment -Antibacterial Degree, Ant-Biofilm

Antibacterial properties are evaluated as follows for the injection molded products prepared in Embodiments and Comparative embodiments.

To confirm the antibacterial power of the antibacterial glass composite according to the present disclosure, ASTM E2149-13a shaking flask method is used.

To confirm the anti-biofilm effect, the standard test method ASTM E2562-12 is used.

Table 2

| | Embodiment 1 | Embodiment 2 | Embodiment 3 | Comparative Embodiment 1 | Comparative embodiment 2 |
|---|---|---|---|---|---|
| Antibacterial degree (ASTM E2149-13a, Shaking flask method.) Staphylococcus aureus | 99.9 % | 99.9 % | 99.9 % | 66.7 % | 40.0 % |
| Antibacterial degree (ASTM E2149-13a, Shaking flask method.) Escherichia coli | 99.9 % | 99.9 % | 99.9 % | 77.1 % | 42.9 % |
| Antibacterial degree (ASTM E2149-13a, Shaking flask method.) Klebsiella pneumococcus | 99.9 % | 99.9 % | 99.9 % | 70.9 % | 73.8 % |
| Anti-biofilm (ASTM E2562-12) Pseudomonas aeruginosa | 99.9 % | 99.9 % | 99.9 % | 98.6 % | 91.2 % |

As shown in Table 2, it is confirmed that the embodiments according to the present disclosure have excellent antibacterial performances.

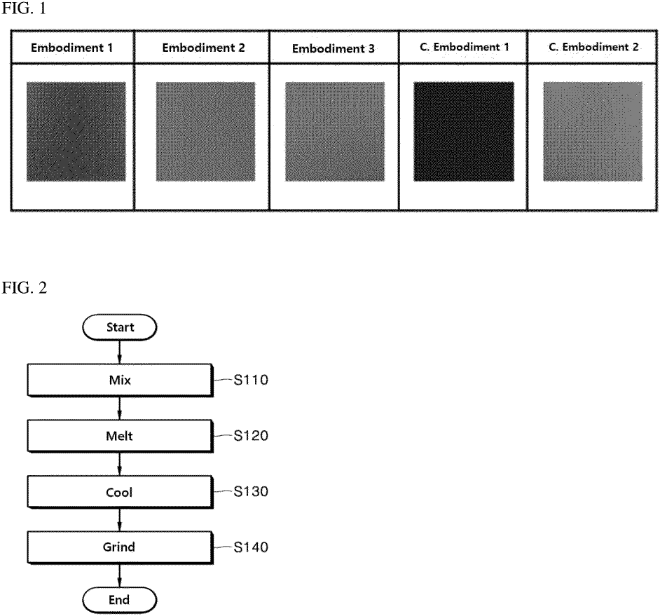

Compared with the embodiments, it is confirmed that the comparative embodiments have quite unsatisfactory antibacterial performances. Referring to FIG. 1, the embodiments show yellow and brown colors but the comparative embodiments show red and gray colors.

### Embodiment 2

### 1. Antibacterial Glass Powder Preparation

### Embodiment 2-1

An antibacterial glass composition having the composition shown in Table 1 may be melted at a temperature of 1,250° C. in an electric furnace. After that, the melt glass composition may be cooled in on a stainless steel sheet in a glass bulk form by the air cooling method, thereby obtaining cullet-type antibacterial glass. Then, the antibacterial glass may be pulverized with a dry grinder (e.g., a ball mill) and passed through a 400-mesh sieve so that antibacterial glass powder having a D90 particle size of 20 µm may be prepared.

### Embodiment 2-2

Antibacterial glass powder having a D90 particle size of 25 µm is prepared in the same method as the method in Embodiment 1, except that the antibacterial glass composition having the composition shown in Table 1 is melted at a temperature of 1,220° C. in an electric furnace.

### Comparative Example 2-1

Antibacterial glass powder having a D90 particle size of 20 µm is prepared in the same method as the method in Embodiment 1, except that the antibacterial glass composition having the composition sho embodimentwn in Table 1 is melted at a temperature of 1,240° C. in an electric furnace.

### Comparative Example 2-2

Antibacterial glass powder having a D90 particle size of 25 µm is prepared in the same method as the method in Embodiment 1, except that the antibacterial glass composition having the composition shown in Table 3 is melted at a temperature of 1,250° C. in an electric furnace.

Table 3

Unit: % by weight

| Classification | Embodime nt 2-1 | Embodiment 2-2 | Comparative embodiment 2-1 | Comparative 2-2 |
|---|---|---|---|---|
| SiO₂ | 26 | 36.7 | 35.1 | 37.1 |
| B₂O₃ | 20 | 7.2 | 6.8 | 10.6 |
| Na₂O | 11 | 11.2 | 10.7 | 13.9 |
| K₂O | 6 | 6.1 | 5.9 | 6.3 |
| Li₂O | 2 | | | 2.5 |
| Al₂O₃ | 1 | | | |
| TiO₂ | 0.5 | | | 13.7 |
| ZnO | 27 | 20.4 | 19.5 | 4.6 |
| CaO | | 10.2 | 9.8 | |
| MoO₃ | | | | 11.3 |
| CuO | 5 | 5.1 | | |
| FeO₃ | 1.5 | 3.1 | | |
| MnO₂ | | | 12.2 | |
| Total | 100 | 100 | 100 | 100 |

### 2. Antibacterial Degree Measurement

Table 4 shows the results of measuring the antibacterial degree of the antibacterial glass power prepared according to Embodiment 201 to 2-2 and comparative embodiments 2-1 to 2-2. In this instance, to confirm the antibacterial degree of each antibacterial glass powder, the antibacterial activity values against Staphylococcus aureus and Escherichia coli are measured by ASTM E2149-13a and a shaking flask method. In addition, the antibacterial activity against pneumococcus and Pseudomonas aeruginosa is further evaluated.

Table 4

| Classification | | Embodiment 1 | Embodiment 2 | Comparative embodiment 1 | Comparative embodiment 2 |
|---|---|---|---|---|---|
| Antibacteri al degree (ASTM E2149-13a, Shaking flask method. | Staphyloco ccus aureus | 99.9% | 99.9% | 60.0% | 75.7% |
| | Escherichia coli | 99.9% | 99.9% | 54.02% | 24.0% |
| | Klebsiella pneumococ cus | 99.9% | 99.9% | 52.0% | 17.4% |
| | Pseudomon as aeruginosa | 99.9% | 99.9% | 79.9% | 34.8% |

As shown in Table 3 and Table 4, it may be confirmed that the antibacterial glass powder prepared according to Embodiments 2-1 to 2-2 to 2 express an antibacterial degree of 99% or more. The antibacterial glass powder prepared according to Embodiments 2-1 to 2-2 show a white color.

However, it may be confirmed that the antibacterial glass powder prepared according to Comparative embodiments 2-1 to 2-2 express an antibacterial degree of 90% or less. The antibacterial glass powder prepared according to Comparative embodiment 2-1 shows a brown color and the antibacterial glass powder prepared according to Comparative embodiment 2-2 shows a transparent color.

### 3. Injection Molded Product Manufacturing

### Embodiment 2-3

2% wt of the antibacterial glass power prepared according to Embodiment 1 and 9% wt of PP (Polypropylene) resin are mixed. After that, the mixture is injection-molded by using an injection molding device, thereby preparing an injection molded product of 200 mm (horizontal), 100 mm (length) and 3 mm (thickness).

### Comparative Embodiment 3

0135] 2% wt of the antibacterial glass power prepared according to Comparative embodiment 2-1 and 98% wt of PP (Polypropylene) resin are mixed. After that, the mixture is injection-molded by using an injection molding device, thereby preparing an injection molded product of 200 mm (horizontal), 100 mm (length) and 3 mm (thickness).

### 4. Antibacterial Activity Measurement

Table 5 shows the results of measuring antibacterial activity for injection molded products prepared according to Embodiment 2-3 and Comparative embodiment 2-3. In this instance, to confirm the antibacterial activity for each injection molded product, antibacterial activity values against Staphylococcus aureus and E. coli are measured by JIS Z 2801 that is an antibacterial standard test method, and film adhesion method. In addition, Antibacterial activity against pneumococcus and Pseudomonas aeruginosa is further evaluated.

Here, the antibacterial activity values are evaluated based on the following conversion method.

| Antibacterial activity value | Antibacterial degree |
|---|---|
| 2.0 or more | 99.0% |
| 3.0 or more | 99.9% |
| 4.0 or more | 99.99% |

Table 5

| Classification | | Embodiment 3 | Comparative embodiment 3 |
|---|---|---|---|
| Antibacterial degree (JIS Z 2801 that is an antibacterial standard test method, and film adhesion method | Staphylococcus aureus | 99.99% | 96.5% |
| | Escherichia coli | 99.99% | 97.1% |
| | Klebsiella pneumococcus | 99.99% | 96.4% |
| | Pseudomonas aeruginosa | 99.99% | 96.7% |

As shown in Table 5, it is measured that the antibacterial activity value of the injection molded product prepared based on Embodiment 2-3 has 2.0 or more and confirmed that it expresses 99% or more of antibacterial degree.

However, it is measured that the antibacterial activity values of the injection molded products prepared according to Comparative embodiment 2-3 have less than 2.0s and confirmed that they express less than 99.0% of antibacterial degree.

As known from the above experimental results, the injection molded product manufactured according to Embodiment 2-3 shows superior antibacterial activity compared to the injection molded product manufactured according to Comparative embodiment 2-3.

The embodiments are described above with reference to a number of illustrative embodiments thereof. However, the present disclosure is not intended to limit the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

1. An antibacterial glass composition comprising:
20 to 60 % by weight (or wt) of SiO₂;
5 to 20% wt of B₂O₃;
10 to 20% wt of at least one of Na₂O, K₂O, or Li₂O;
20 o 35% wt of at least one of ZnO, CaO, or MgO;
0.01 to 0.1 %wt of Ag₂O;
2 to 6 % wt of CuO; and
4 to 15 % wt of Fe₂O₃.

2. The antimicrobial glass composition of claim 1, wherein the antimicrobial glass composition comprises a content of SiO₂ that is more than a content of B₂O₃.

3. The antimicrobial glass composition of claim 1, wherein:
$$1.5 \leq \left[\% {\text{wt of Fe}}_{2} {\text{O}}_{3} / \% \text{wt of CuO}\right] \leq 4.5.$$
.

4. The antimicrobial glass composition of claim 1, wherein the antimicrobial glass composition comprises a total content of Fe₂O₃ and CuO that is 20% wt or less.

5. A manufacturing method of an antibacterial glass composite manufacturing method comprising:
preparing an antibacterial glass composite comprising:
20 to 60 % by weight (or wt) of SiO₂;
5 to 20% wt of B₂O₃;
10 to 20% wt of at least one of Na₂O, K₂O, or Li₂O;
20 to 35% wt of at least one of ZnO, CaO, or MgO;
0.01 to 0.1 %wt of Ag₂O;
2 to 6 % wt of Cuo; and
4 to 15 % wt of Fe₂O₃;
melting the antibacterial glass composite; and
cooling the melted antibacterial glass composite on a quenching roller.

6. The manufacturing method of the antibacterial glass composite of claim 5, wherein the antimicrobial glass composite comprises a content of SiO₂ that is added more than a content of B₂O₃.

7. The manufacturing method of the antibacterial glass composite of claim 5, wherein:
$$1.5 \leq \left[\% {\text{wt of Fe}}_{2} {\text{O}}_{3} / \text{\% wt of CuO}\right] \leq 4.5.$$
.

8. The manufacturing method of the antimicrobial glass composite of claim 5, wherein the antimicrobial glass composite comprises a total content of Fe₂O₃ and CuO that is 20% wt or less.

9. An antibacterial glass composite comprising:
20 to 40 % by weight (or wt) of SiO₂;
25 to 45% wt of a sum of B₂O₃ and P₂O₅;
5 to 20% wt of at least one of Na₂O, K₂O, or Li₂O;
0.1 to 10 %wt of Alg₂O₃;
5 to 15%wt of TiO₂;
1 to 8 %wt of ZnO; and
0.1 to 2%wt of Ag₂O.

10. The antibacterial glass composite of claim 9, wherein the antibacterial glass composite comprises:
B₂O₃ in an amount of 20 to 40%wt, and
P₂O₅ in an amount of 8%wt or more.

11. The antibacterial glass composite of claim 10, wherein the antibacterial glass composite comprises of 8 to 15 %wt of P₂O₅ . .

12. The antibacterial glass composite of claim 9, wherein the antibacterial glass composite comprises:
Li₂O in an amount of 3%wt or less.

13. An antimicrobial glass powder preparation method comprising:
forming an antibacterial glass composition including:
20 to 40 % wt of SiO₂,
25 to 45% wt of a sum of B₂O₃ and P₂O₅,
5 to 20% wt of at least one of Na₂O, K₂O, or Li₂O,
0.1 to 10 %wt of Al₂O₃,
5 to 15 % wt TiO₂,
1 to 8%wt of ZnO; and
0.1 to 2 % wt of Ag₂O, ;
melting the antimicrobial glass composition;
cooling the melted antimicrobial glass composition;
grinding the cooled antimicrobial glass.

14. The antimicrobial glass powder preparation method of claim 13, wherein the antimicrobial glass composition includes:
B₂O₃ in an amount of 20 to 40%wt, and
P₂O₅ in an amount of 8%wt or more.

15. The antimicrobial glass powder preparation method of claim 13, wherein the antimicrobial glass composition includes P₂O₅ in an amount of 8 to 15%wt.

16. The antimicrobial glass powder preparation method of claim 13, wherein the antimicrobial glass composition includes Li₂O in an amount of 3 %wt or less.
